(19) United States
(12) Patent Application Publication
(10) Pub. No.: US 2008/0005168 A1
(43) Pub. Date: Jan. 3, 2008

(54) MANAGING FAMILY INFORMATION

(75) Inventors: Arlene Huff, Redmond, WA (US); Tim Lebel, Redmond, WA (US); Rogers Weed, Seattle, WA (US)

Correspondence Address: BANNER & WITCOFF, LTD.;ATTORNEYS FOR CLIENT NOS. 003797 & 013797, 1100 13th STREET, N.W., SUITE 1200, WASHINGTON, DC, 20005-4051, US

(73) Assignee: MICROSOFT CORPORATION, Redmond, WA (US)

(21) Appl. No.: 11/428,182

(22) Filed: Jun. 30, 2006

(51) Int. Cl. G06F 17/00

(52) U.S. Cl. 707/104.1

(57) ABSTRACT

Family information adaptable for groups with multiple members using multiple devices in multiple locations can be managed. Extensible and customizable types of family information, such as notes, tasks, lists, and appointments for specific family activities may be stored in a data store on a local or remote server. Multiple family members may enter information into the data store and retrieve information from the data store, allowing for coordination of tasks and activities.

### BACKGROUND

Personal information management (PIM) software has made great strides in recent years. People use PIM software everyday to manage their email, tasks, calendars, and contacts, among other information. However, the storage, organization, and management of ones own personal information may be of little value unless the personal information of ones family members, friends, or other associates can be integrated into a single management system. As an example, families today are busier than ever; they work, travel, and play, individually and together as a family, more than ever before. Parents pack their schedules and plan longer in advance for family events and long-term goals such as saving for college educations. Even children frequently keep busy schedules involving structured activities. Family members spend more time outside of the house, yet have even greater need to stay connected to coordinate the day-to-day tasks and activities of the family. Similarly, businesses and other groups rely heavily on PIM software, yet the more information users try to manage in PIM software, the more difficult it becomes for users to coordinate and exchange information with their colleagues, friends, classmates, teammates, or roommates.

For several years, paper and electronic calendars have been introduced as attempts to address the difficulties in coordinating family activities, and as solutions for staying connected with other family members. However, these existing electronic calendars and other PIM solution software have failed to produce an adequate environment for a family to organize its activities and communications. For example, many electronic calendars are mere home appliances, providing robust scheduling support, but leaving family members isolated whenever they leave the house. Even electronic calendars that can “sync” to a mobile device before a family member leaves the house will only in effect provide a portable snapshot of the calendar, rather than actually connecting family members in different locations. Existing solutions have also failed to provide easy ways to import data into the system from different devices and from different physical locations, and have not adequately supported flexible information management scenarios. For example, some existing calendars may be stored online and are configurable for access outside of the home, but such solutions fail to support the types of flexible communications used by families and groups for real-life information management, such as notes and messages, tasks, and lists, allowing certain items to be exposed only to certain family members, and allowing ‘chunkier’ scheduling, or scheduling of activities, tasks, and events at less precise and more flexible times.

### SUMMARY

The following presents a simplified summary of the invention in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

Illustrative aspects of the present invention are directed to managing family information in a data store. Integrated information, including, but not limited to, notes, lists, tasks, appointments, contacts, activities, and links may be stored, retrieved, and displayed to users on display devices. Items may be stored in a data store and associated with one or more family members, or with the family as a whole. Family members may retrieve or update certain of their own items, family items, and items associated with other family members. Access to family information by family members and non-members may be controlled by stored permissions associated with items and/or users. Items in the data store may also be accessed based on stored times or types associated with the information, allowing users to interact with the display to define and view items based on times, locations, data types, and the family members or other people associated with the item. Another illustrative aspect includes one or more computer readable media storing the above-described data store and computer executable instructions.

According to another aspect of the present invention, different information management functionality may be implemented in plug-in modules, allowing each family management system to be extended and customized to match the needs and preferences of the family members. Modules may be activity-specific, and may be independently developed and installed onto the system. Data storage for modules may be integrated into the existing family information management system data store, or may be maintained externally at a different physical storage location.

According to another aspect of the present invention, family members may stay connected to the family information management system, and thus to other family members, through connection of different mobile devices and other computing devices in different locations to the family management system. Tasks, appointments, activities, notes, and other information may be communicated between multiple devices, and may be synchronized between multiple data stores. Family data may be accessible through a simple Internet kiosk, and may also be made available offline on family member's computing devices when no Internet connection is available. Additional content, such as advertising content from an advertising server may be generated and displayed for users based on other family information in the data store.

### BRIEF DESCRIPTION OF THE DRAWINGS

The foregoing summary, as well as the following detailed description, is better understood when read in conjunction with the accompanying drawings, which are included by way of example, and not by way of limitation and in which like reference numerals indicate similar elements.

FIG. 1 illustrates a schematic diagram of a general-purpose digital computing environment in which certain aspects may be implemented.

FIG. 2 is a schematic diagram showing an illustrative component architecture diagram for a family information management system, according to aspects of the present invention.

FIG. 3 is a flow chart showing an illustrative implementation of a family information management technique, according to aspects of the present invention.

FIG. 4 illustrates a table for storing group information usable in a data store, according to aspects of the present invention.

FIG. 5 is a flow chart showing an illustrative implementation of a group information management module, according to aspects of the present invention.

FIG. 6 is a schematic diagram of an illustrative network of a group information management system, according to aspects of the present invention.

FIGS. 7-10 are screenshots of user interface views from an illustrative family information management system, according to aspects of the present invention.

### DETAILED DESCRIPTION

In the following description of the various embodiments, reference is made to the accompanying drawings, which form a part hereof, and in which is shown by way of illustration various embodiments in which features may be practiced. It is to be understood that other embodiments may be utilized and structural and functional modifications may be made.

### Illustrative Operating Environment

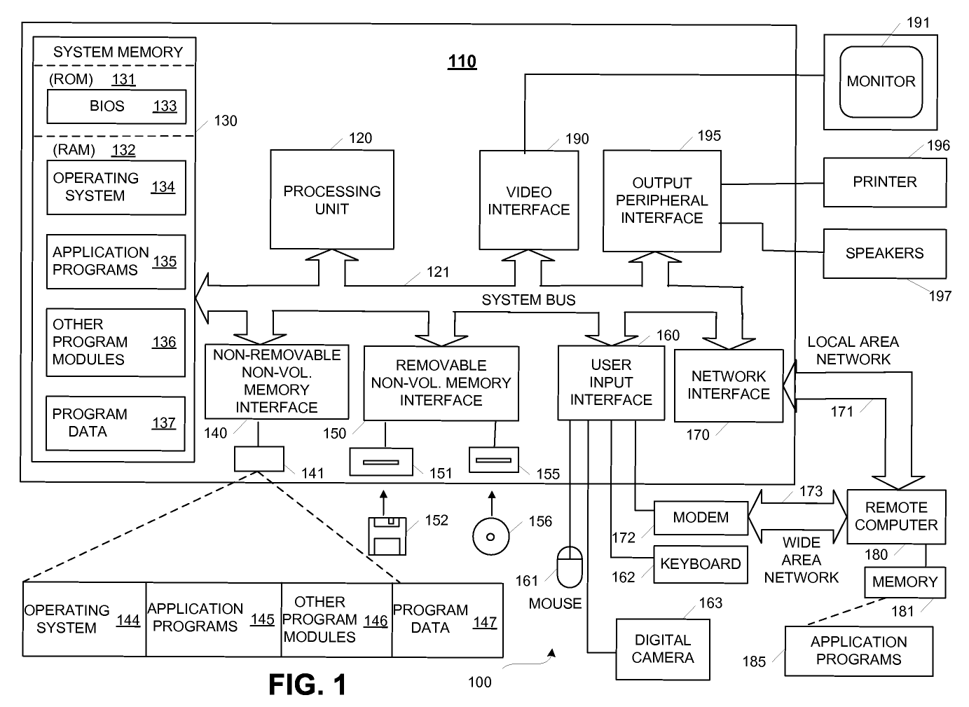

FIG. 1 illustrates an example of a suitable general purpose computing system environment 100 on which one or more illustrative aspects may be implemented. The computing system environment 100 is only one example of a suitable computing environment and is not intended to suggest any limitation as to the scope of use or functionality of features described herein. Neither should the computing environment 100 be interpreted as having any dependency or requirement relating to any one or combination of components illustrated in the exemplary operating environment 100.

Aspects are operational with numerous other general purpose or special purpose computing system environments or configurations. Examples of well known computing systems, environments, and/or configurations that may be suitable for use with aspects of the invention include, but are not limited to, personal computers; server computers; mobile phones, portable and hand-held devices such as personal digital assistants (PDAs), tablet PCs or laptop PCs; multiprocessor systems; microprocessor-based systems; set top boxes; programmable consumer electronics; network PCs; minicomputers; mainframe computers; distributed computing environments that include any of the above systems or devices; and the like.

Aspects of the invention may be described in the general context of computer-executable instructions, such as program modules, being executed by a computer. Generally, program modules include routines, programs, objects, components, data structures, etc. that perform particular tasks or implement particular abstract data types. Aspects of the invention may also be practiced in distributed computing environments where tasks are performed by remote processing devices that are linked through a communications network. In a distributed computing environment, program modules may be located in both local and remote computer storage media including memory storage devices.

With reference to FIG. 1, an illustrative system for implementing one or more aspects of the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Advanced Graphics Port (AGP) bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may include computer storage media and communication media. Computer storage media includes both volatile and nonvolatile and removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include electronic pen (e.g., a stylus), a microphone, joystick, game pad, satellite dish, scanner, or the like. These and other input devices are often connected to the processing unit 120 through a user input interface 160 that is coupled to the system bus 121, but may be connected by other interface and bus structures (not shown), such as a parallel port, game port or a universal serial bus (USB). A monitor 191 or other type of display device is also connected to the system bus 121 via an interface, such as a video interface 190. In addition to the monitor 191, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet. For example, computer 110 may be connected to a mobile terminal (not shown) which is configured to send and receive transmissions based on the Bluetooth standard, through a specific Bluetooth module. Additionally, computer 110 may also be configured to receive, decode and process transmissions with a remote computer 180 or mobile terminal through an FM/AM radio receiver, wireless local area network (WLAN) transceiver, and/or telecommunications transceiver.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates application programs 185 as residing on memory device 181. It will be appreciated that the network connections shown are exemplary and other means of establishing a communications link between the computers may be used.

One or more aspects of the invention may be embodied in computer-executable instructions (i.e., software), such as in a notification manager software object, routine or function (collectively referred to herein as a notification manager) stored in system memory 130 or non-volatile memory 141, 152, 156 as application programs 135, 145, program modules 136, 146, and/or program data 137, 147. The software may alternatively be stored remotely, such as on remote computer 180 with application programs 185. Generally, program modules include routines, programs, objects, components, data structures, etc. that perform particular tasks or implement particular abstract data types when executed by a processor in a computer or other device. The computer executable instructions may be stored on a computer readable medium such as a hard disk 141, optical disk 156, removable storage media 152, solid state memory, RAM 132, etc. As will be appreciated by one of skill in the art, the functionality of the program modules may be combined or distributed as desired in various aspects. In addition, the functionality may be embodied in whole or in part in firmware or hardware equivalents such as integrated circuits, field programmable gate arrays (FPGA), and the like.

### Illustrative Aspects

The following aspects will refer to components compatible with a Windows based operating system. It will be understood, however, that aspects of the invention will apply similarly to other operating systems including, but not limited to, Mac and Linux based operating systems.

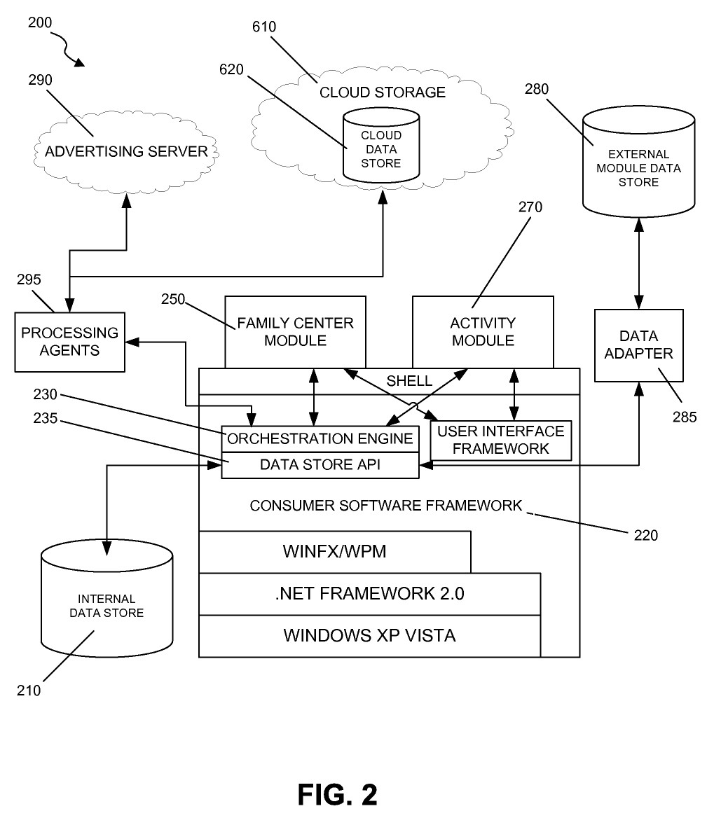

Referring to FIG. 2, a schematic diagram is shown illustrating a possible component architecture for a family information management system 200. In this example, the CSF Local DataStore (internal data store) 210 is the primary data store for all family data entered into the information management system. It should be noted that although system 200 may have a single internal data store 210, the present disclosure is not limited to such uses. For example, references to the data store 210 may also refer to an external storage (e.g., external module data store 280) on a different computing device from the device on which the system 200 is installed, or may refer to a data store in an Internet-based storage (e.g., cloud data store 620) as described below. These individual pieces of family data may be stored in an internal data store 210, such as a database stored on hard disk drive 141, or in an alternative computer storage, such as a removable optical disk 156. As in this example, the data store 210 may be implemented on a lightweight file-based database engine including a query parser, optimizer, and query processor, such as a Microsoft SQL Mobile Database engine. The data store 210 may also support some or all of the ANSI 92 SQL specification.

Referring again to FIG. 2, a central tier of the architecture is the consumer software framework (CSF) 220, which provides application services to activity module(s) 270. The CSF 220 may provide object libraries and interfaces for use by module developers, such as user interface (UI) components, data management, module management, advertising services, output services (to printer, phone, etc), and configuration services. This support in the CSF 220 may allow for reduced module development time and may improve consistency, quality, and performance of the user experience. The CSF 220 may also include built-in support for calendar, contact, and list objects that are made available for use by activity module(s) 270 connected to the CSF 220. Installation of the family information system 200 may involve storing the executable software of the CSF 220, family center module 250, among other system components, in the application programs storage 135 of computer 110. The family center module 250 provides the primary connected user experiences that use these core objects. Any additional activity module(s) 270, such as third-party software plug-in modules developed for a family information management system, may be required to provide certain components such as an activity module UI, an optional module-specific (external) data store 280 including a database and a data adapter 285 so that the operations supported by the family information management system 200 may execute correctly across multiple data stores 210 and 280.

In this example, the CSF includes an “orchestration engine” 230 for managing system events, handling system security, and performing other business logic within the family information management system 200. To perform these tasks, the orchestration engine 230 may communicate with external services such as an advertising service on advertising server 290, through processing agent(s) 295, or other external web services (e.g., storage for calendar, contacts, and list data). In this example, the orchestration engine 230 may add a new processing agent 295 to the system 200 to enable communication with the new advertising service on advertising server 290. The orchestration engine 230 may include a data store API 235 to provide support for modules for storing and retrieve user and family data from the local data store 210. Certain software plug-in modules (e.g. activity module 270) may use their own data store (e.g., module data store 280). Any activity module(s) 270 transacting their own data types (e.g., module-specific custom data types) may be required to implement a data adapter component 285, and to register the data adapter 285 with the orchestration engine 230, to allow the orchestration engine 230 to route each module's data requests appropriately. Note that the data adapter model might also be used to connect devices such as bar-code scanners or satellite systems to the family information management system 200. A data adapter 285, registered with the orchestration engine 230, may be responsible for identifying the device and handling any data translation tasks.

The advertising service from advertising server 290 may coordinate with the orchestration engine 230 through a processing agent 295 to integrate customized content into the family information management system 200. For example, information describing the tasks and activities of a family may be communicated to the advertising server 290. In response, certain advertising content may be transmitted back to the system 200, or directly to other computing devices, such as mobile phones and PDAs, and delivered (e.g., displayed) to family members through these devices. The family information management system 200 may include a component dedicated to monitoring past and present family usage to intelligently (e.g., through the use of algorithms and heuristics based on the information in the data store(s)) present advertising and other offers to users.

This advertising content may be displayed on the monitor 191 or other device display at selected times during user interaction, so that users may receive targeted and relevant advertising content based on recent task or activity information. An additional aspect of advertising via the family information management system 200 allows for configuration of the system 200, enabling parents to protect their children from inappropriate advertisements or other undesirable content. Thus, advertising content sent to users may be customized based on activities or tasks that the user has performed or is likely to perform, the time and location at which the activity or task may be performed, the identity of the user, the technical capabilities of the user's device, and family wide or individual user preferences.

Finally, as shown in FIG. 2, the CSF 220 may be built on top of a pre-existing component architecture that is installed with the operating system. For example, the CSF 220 may be built on Microsoft Windows XP, Microsoft.Net Framework 2.0, and/or Microsoft WinFX technologies, which includes Windows Presentation Foundation.

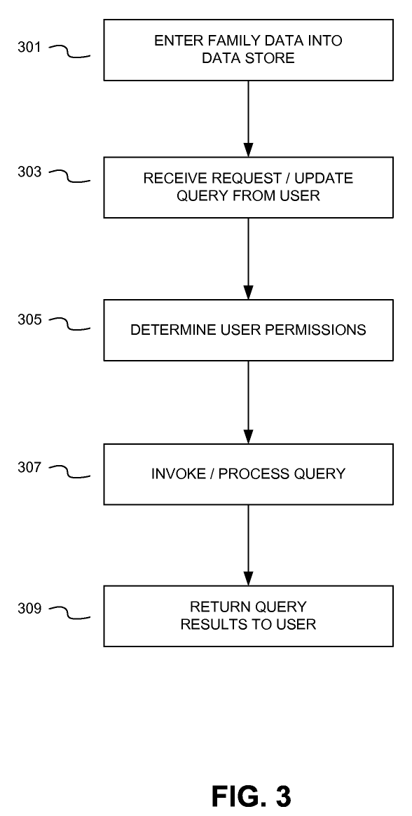

Referring to FIG. 3, an illustrative process is shown for managing family information. In step 301, family data is entered in a data store 210 such as a database. As mentioned above, the data store 210 stores and controls access to the entered family data. The family data refers to data items associated with a designated group of people, or family. While a family may refer to a set of individuals who are actually genetically related, the present disclosure is not limited as such. Alternative “families” might be sports teams, roommates in a house or apartment, classmates, friends, or any other group of people or things linked by common person, location, or activity.

The family data stored in the data store 210 may be of practically any type. In certain aspects, the data store 210 supports a standard default set of data types. For example, each family management system might support the following: calendar data storing the appointments of one or more family members, contact data storing contact information of or obtained by a family member; task data storing tasks designated for one or more family members; and notes storing graphical, text, voice, typed, and/or handwritten notes (e.g., using an electronic pen) sent to or from a family member or created as individual reminders. Additionally, certain types of information may be received by the system 200 and assigned a certain data type, and then may be converted to another data type based on natural language algorithms and/or other family data. For example, a handwritten or phoned-in note might be automatically assigned the note data type. Subsequently, when the data in the note is determined to describe another type of information, such as an appointment or a contact, the item may be converted to the appropriate data type in the system 200.

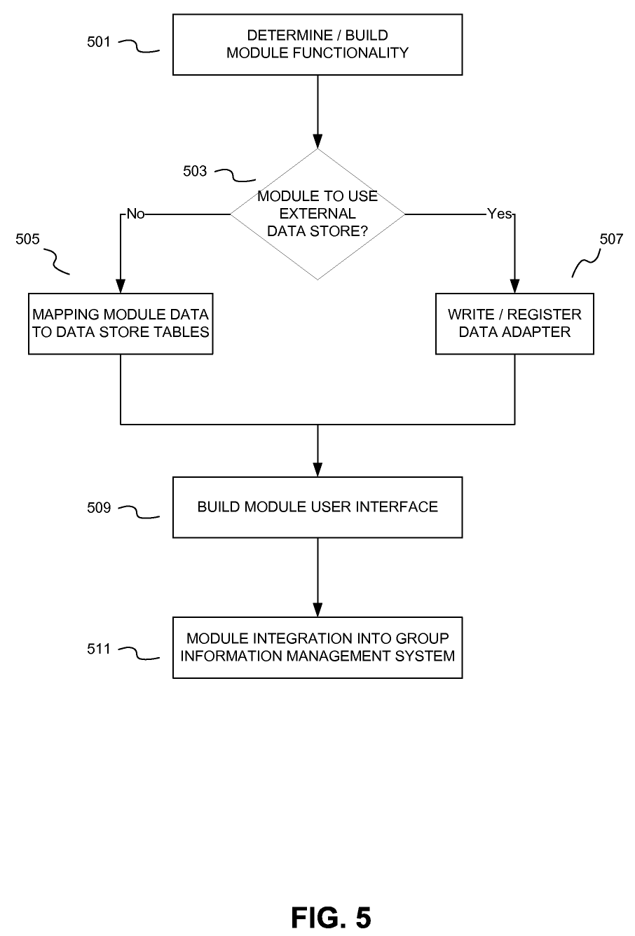

In some embodiments, the data store may support storage and access of additional data types. For example, data type, or activity, modules may be implemented as part of the original family information management system, or may be implemented as separate software plug-in modules which are compatible with the system and may be installed at a later time. When modules are implemented as software plug-ins or proprietary software applications, they may either use the data store and database provided by the out-of-the-box family management implementation, or they may provide their own database engine and storage. Thus, a data store 210, or computer storage, may include a single database or a combination of multiple databases for multiple activity modules. The implementation of activity modules will be discussed further below with reference to FIG. 5.

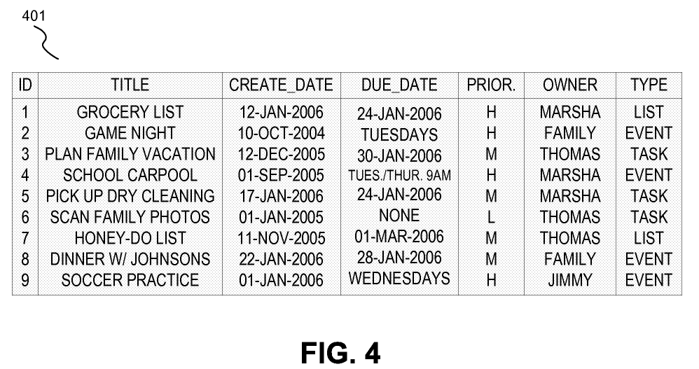

FIG. 4 illustrates a sample table 401 which may be used to store individual and group items in data store 210. Table 401 is but one illustrative example, and other database tables may include more or fewer rows and/or columns storing different or additional information. For example, the Due_Date field may further include a time of day in which or by which the item preferably should be completed. Due_Date may alternatively be specified and/or displayed in terms of ‘chunky’ time, a less precise and more flexible definition of the time and/or date than the date and time data types commonly stored in a computer storage. The Priority (Prior.) field may include different or additional levels of priority, e.g., urgent/not urgent, instead of high (H), medium (M), low (L). Other priority levels may alternatively be used, e.g., “must do,” “optional,” and “none.” The Type field may include additional or different types of items, e.g., communications, link, etc.

Referring again to FIG. 3, in step 303 the family information management system receives a query from a user relating to certain information in the data store 210. In one possible scenario, the querying user is operating a remote computing device connected to the data store (e.g., internal data store 210 or cloud data store 620). For example, a family member may use their personal mobile terminal while away from home to communicate with a data store 210 located at a home computer. The user of a mobile computing device or a home-roamable device may connect with the Internet-based cloud storage 620 synchronized with a home-based data store 210, as discussed in detail below. Of course, the data store 210 and other aspects of the family information management system may be configured so that non-family members can send queries and receive the results of their queries. As described in detail below, certain non-family members such as friends and acquaintances may be designated permissions on some or all items in the data store 210. The query sent to the data store 210 in step 303 may be either a request query to retrieve data, or an update query to add or update data in the data store 210 or cloud 620. The family information management system may use the orchestration engine 230 to broker queries and other requests for services from various modules to the data store 210 or cloud 620.

Another aspect relates to the storage and sharing of data between different family management information systems 200. For example, an additional public data store (not shown) in the cloud storage 610 may hold a repository of indexed calendar items, lists, contacts, and other types of family information from many different family systems 200. An individual system 200 may then easily search and import data from the repository into the family's system 200. Since the storage location and data format and/or data types may stay relatively unchanged in the repository, the searching, posting, and retrieving operations may be simpler and more consistent than performing typical Internet searches or connecting to a single family's system. To illustrate some potential advantages, consider multiple families with information management systems 200 whose children play on the same soccer team. The families may decide not to set up a separate system 200 dedicated to the soccer team, but instead may use the repository (e.g. Microsoft Content Central) to store and share team-related information. The systems 200 of the individual families can connect to the repository to search for and bring down team news, schedules, game pictures, or other team information, without relying on a system 200 or web site maintained by a single family, and without performing a broad Internet search. Of course, families may choose not to post private family information to the repository. Additionally, a designated storage area in the repository may include information posted by the repository administrator. It should also be noted that searches and downloads from the repository may occur in response to a direct user request, or alternative may be initiated at least in part automatically be the family system 200 (e.g., based on family member preferences, or searches or heuristics generated from stored family data).

In step 305, the family information management system determines a level of user permissions associated with the querying user. In certain systems, the identity of the user is first determined and then used to look up data store permissions in an access control list (ACL) table. User permissions may be set on the whole data store 210 or may be customized to apply to individual family data items. While users might simply be family members with complete access to all family data in the data store 210, a variety of other different permissions scenarios may be supported. For example, a family may share a common calendar so that each family member can view and update the items in the calendar, while certain family members may maintain their own personal calendars for which other family members and non-family member have either view only access or no access. In such a system, a family member might allow other family members to see some details of an item (e.g., the time of an appointment) without allowing them to see other details of the same item (e.g., the description and details of the appointment). Similarly, the person in charge of the family finances may allow another family member to view all bills and account balances, but might not allow them to edit any account information or pay any bills.

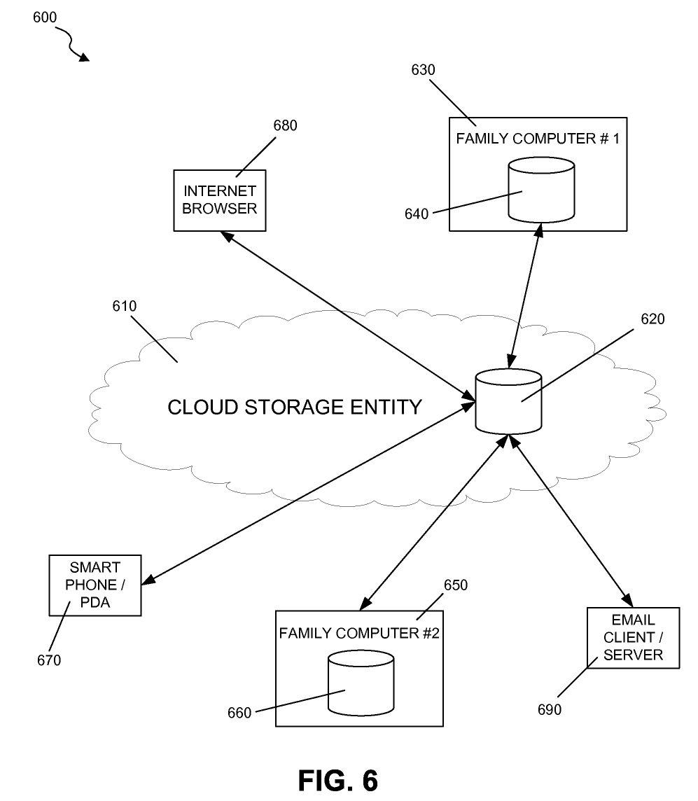

In step 307, the user query is executed, for example, by using processing unit 120 to invoke the query logic of the data store query processor against the database tables in the data store 210. As described in detail below, the user may receive a full or partial data set based on the specific items for which that user has access. Additionally, since many types of data, such as family activities and tasks, may be stored in the family information management system 200, the user query may originate from a remote computing device such as a home computer or mobile terminal. As an example, a husband out running errands might want to check the family to-do list for the day using his mobile phone, remotely executing a query of the data store (e.g., cloud data store 620 or data store 210 residing on the family's home computer 110). Then upon completing a task from the list, he can use the mobile phone to mark the task as completed. This action may then synchronize with the family's home computer 110 and the various other devices connected to the family information management system 200. Thus, a wife leaving work may check her mobile terminal to see that her husband has completed that task, and might see other tasks that have not yet been checked off of the list. Such synchronization and other updates may occur automatically (i.e., without an explicit user command to synchronize the device), manually, or according to a schedule configurable by the family members. Synchronization technologies are discussed in greater detail with reference to FIG. 6.

The family information management system 200 running on the computing device 110 may potentially be connectable to other devices including, but are not limited to, the following: a land line telephone, a desktop computer at home or at a workplace, a digital camera 163, a scanner, a tethered or wireless personal digital assistant (PDA), a smart phone or PDA phone, a cellular phone, a tablet PC, a radio-frequency (RF) home network, a medical device, and/or a barcode reader. These devices may be connected locally or remotely over local area network 171 or wide area network 173 to capture and exchange the types of family information supported by the system 200.

While the present disclosure is not limited to any specific table schema in the storage of the data store 210, an [Items] table may be provided in certain aspects including a record in the table for each task, activity, note, contact, etc. family item in the system 200. An [Items] table, similar to that described in reference to FIG. 4, might also include a column specifying the category, or type, of item, as well as columns to specify the description, time, family members, and permissions associated with each item in the table. A single flat table, such as the [Items] table may potentially allow for more efficient indexing and record searching capabilities compared to configurations in which multiples tables are used to store family items.

In step 309, query results are returned to the user. As mentioned above, this step may be optional. Depending on the device and/or the action performed by the query, it may be preferable not to return a result set or even an error message to the querying user. For example, a family member using a short message service (SMS) message to report completion of a task on the family to-do list, might not desire any response from the family information management system 200. The determination of when query results/confirmations are returned to the user may be configurable by the family members interacting with the system 200.

As mentioned above, various levels of user permissions may be supported to provide more robust or efficient operation of the data store. For example, if it were determined in step 305 that the requesting user has no permissions of any kind with respect to the data store 210, then of course the query need not be executed at all (step 307) and an appropriate error message could be directly returned to the user. In certain aspects, this determination need not take place within the data store, or even within the family information management system 200. Instead, user permissions may initially be determined at the network or operating system level (e.g., in step 305), prior to any permissions checks which occur in the family information management system 200. After an initial determination in step 305 that the user does have certain permissions on the system or on data store 210, another determination can be made (e.g., in step 307) to confirm that the exact records that the user is requesting or attempting to update fall within the scope of that user's permissions. One possibility for handling a user query for requesting or updating items for which the user does not have access, is to simply deny the request and return an error message to the user. Alternatively, the user may receive an indication that the query was successfully performed, along with a partial or empty result set for the data store items for which the user does have access.

Referring now to FIG. 5, a flow diagram is shown illustrating the creation and integration of a module into the family information management system 200. In step 501, the concept and supported functionality of the module is determined, and this functionality is implemented as software or as a combination hardware-software solution. As mentioned above, the concept of a module might typically relate to a common family task or activity. For example, modules such as a Household Budgeter, a Meal Planner, a Health Tracker, a Money Organizer, and a Shopping List, to name just a few, may be added to a family's information management system 200 to provide customized data management depending on the needs and activities of the family. While modules are often referred to as activity modules and may relate to certain types of activities performed by the family members, modules need not be tied to specific activities, but might instead simply represent a certain type of data to be stored and a certain functionality associated with that data. It should also be noted that data types need not be specific to a single module. For example, a ‘Team Tracker’ module for allowing family members to track their favorite sports teams may include event data (e.g., notifications of game times, locations, TV schedules), list data (e.g., team roster and statistics), and may also define and implement new data types specific to this module. Thus, module developers may leverage the data types and functionality supported by the default out-of-the-box family management system 200, while also being able to implement their own custom data types and functionality specific to the tasks and/or activities relevant to the module.

A module developer, for example, a third-party software vendor, may implement a new module as a software plug-in designed to be compatible with the supported interfaces of the family information management system 200. The system 200, besides publishing and supporting these module integration interfaces, may also provide code samples to assist developers in the creation of modules to extend and customize the family management capabilities of the system 200. A module development wizard may also be supported, for example, using Microsoft Visual Studio technology, to enable family members or third-party developers to more quickly and easily create, install, and set up new activity modules for the family management system 200.

Once the concept, data types, and supported functionality for a module are determined, the module developer decides in step 503 whether or not the module will use the data store 210 provided by the system 200 or an external data store. If the module data is to be integrated into the system data store 210 (503:No), then the module developer may be responsible for mapping module data to the structure of the data store in step 505. In certain aspects, the module may provide the system 200 with a manifest including the information needed to setup and install the module automatically on the system 200. The manifest may include, for example, definitions of new data types, definitions of the new properties or groups of properties (sometimes called ‘facets’), suggestions for the designation of indexes, and mappings of data to tables in the data store 210. It should be noted that the mapping step 505 may trigger synchronization between multiple data stores in the system 200, discussed in detail below in reference to FIG. 6.

If the module data is to be stored externally from the data store 210 (503:Yes), then the module developer will be largely responsible designing and implementing the data storage mechanisms for the module. For example, the module developer may create a separate external database dedicated to storing data relating to the new module. In contrast to modules which persist to the system data store 210, the module developer may therefore be responsible for defining the database schema, defining database indexes, and maintaining the database after the setup and installation of the module. Additionally, external data storage may require the module developer to consider and provide support for data synchronization with the data store 210 and/or other system 200 data stores or other devices, periodic data backup, data store encryption support, and data store security and performance.

One possible external storage location is a ‘Cloud’, or Internet-based accessible storage 610. One example is the online Microsoft Networks (MSN) Live Cloud supported by the Microsoft Corporation. MSN Live is further described below in reference to FIG. 6. Persisting data in a cloud storage data store 620 may have potential advantages for module developers, such as out-sourcing the database optimization, security, and maintenance tasks described above. However, such a remote storage might be less preferred to module developers or family members in certain situations. For example, security, privacy, or offline availability considerations may compel local storage (i.e., within a device in the household or under the physical control of a family member). As another example, third-party module developers might prefer to maintain the data store for their modules at their own facility for reasons such as security, performance optimization, data mining, and/or advertising.

Another possible external storage location is a computing device of a family member other than the device on which the system 200 is installed. For example, a module may be designed such that its data is stored not at a family's home computer where the information management system 200 is installed, but at a family member's laptop or mobile terminal, to be synchronized with the system data store 210 as described below in reference to FIG. 6.

In step 507, the module developer provides a data adapter 285 enabling communication between the family information management system 200 and the external data store. For example, data adapters 285 may register with the orchestration engine 230, allowing the orchestration engine 230 to route each module's data requests appropriately. A data adapter model may also be used for connected devices such as bar-code scanners or a satellite system. In such configurations, a data adapter 285, registered with the orchestration engine 230, may be required to identify the device and handle any data translation tasks. This interaction between the orchestration engine component 230 and data adapter components 285 thus allows for the system 200 to persist family data in multiple physical locations, while providing seamless and coherent interactions with this data from the user's perspective.

In step 509, the module developer and/or family member may define a user interface for the new module. For certain modules using external data storage 280 and data adapters 285, the system 200 may require that the module provide the user interface (UI). However, for other modules, the system 200 may provide support for module developers to easily create a module UI, for example, through definition of UI components in a manifest, or through a Microsoft Visual Studio wizard for UI design that can be invoked during the installation or setup of the module. Thus, the system 200 may provide a set of reusable UI components to provide a consistent look and feel across modules, even though the modules may be independently developed.

Finally, in step 511, the module is integrated as a functional part of the family information management system 200. This step may include the installation and setup of the module functionality, data storage, and/or user interface, onto the device running system 200. As mentioned above, when certain module components are stored externally to the device running the system, step 511 may include the definition of interfaces to establish communications between the multiple devices.

Referring now to FIG. 6, a schematic diagram is shown of an illustrative family information management system 200 including a network 600 with computing devices. As shown in FIG. 6, a single instance of a family management system may include multiple data stores on multiple devices, and may support interaction with other devices and software without data stores. As mentioned above, a cloud storage entity 610, such as the MSN Live Cloud, may contain a data store 620 dedicated to storing family information for the system 200. As indicated by the arrows in FIG. 6, the cloud data store 620 is the accumulation point for all data entering and leaving the system 200, to and from the different connectable computing devices in this example. In other examples, one of the other computing devices may be the designated data accumulation point, or cloud storage 610 might not be used at all. In any of the above described configurations, the cloud data store 620, or other data stores for the system 200 may be configured to require user credentials before access to the data store is granted. For example, access to the cloud data store 620 may require an account on the Microsoft Passport Network with read and/or write privileges. The other computing devices that are running software from the family information management system 200 may keep these credentials stored on the device, so that the system 200 may synchronize family data without requiring user intervention.

Further shown in this example, two family computers 630 and 650 contain data stores 640 and 660, respectively. As discussed above, these data stores may be replicas of the cloud data store 620, and may store all of the family information in the system 200. Alternatively, one or both of these data stores 640 and 660 may be used for storing a subset of family data, for example, data associated only with specific modules or specific family members. Other devices, such as a computer running Internet browsing software 680, a smart phone or PDA 670, and a computer running email client or server software 690 might not contain the same family information management system software as computer's 630 and 650, but might nonetheless be connectable to one or more of the data stores 620, 640, and 660, to exchange data and provide family management functionality to users of these devices.

FIG. 6 also illustrates aspects related to synchronization, roaming, and data sharing. A few of the techniques related to implementing these aspects are described below. In many cases, the synchronization, roaming, and data sharing operations may be hidden from the family members, providing the family with a usable and seamless information management system 200. Thus, in certain aspects, the system may be configured to obscure from users issues such as support for multi-master sync, user privileges, reacting to bandwidth limitations, security, and differing data storage formats.

Synchronizing technologies may be used for various communications in the system 200, based on the device types, communication medium connecting the devices, the network, and the amount and types of data being synchronized, among other factors. The following list of synchronization technologies may be used to control the flow of data between the data stores 620, 640, and 660, and between the data stores and all connectable devices: iCal—a technology based on RFC 2445 implementing a commonly used format to share calendar data; Simple Sharing Extensions (SSE)−a Rich Site Summary/Really Simple Syndication (RSS) based technology that extends RSS to support multi-master sync; Harmonica—a synchronization technology developed by the Microsoft Corporation to provide a uniform technique for multi-master synchronization across all data types; Ssync—a mobile device synchronization Web Service developed by the Microsoft Corporation; AirSync—a synchronization solution developed for communication with Microsoft Exchange Server; Synchml—a transport solution to enable synchronization over different carriers; and Msync—a protocol for a Microsoft Windows Live client for use on various phones and PDAs. Additionally, peer-to-peer (P2P) connections between devices may be used to share family data.

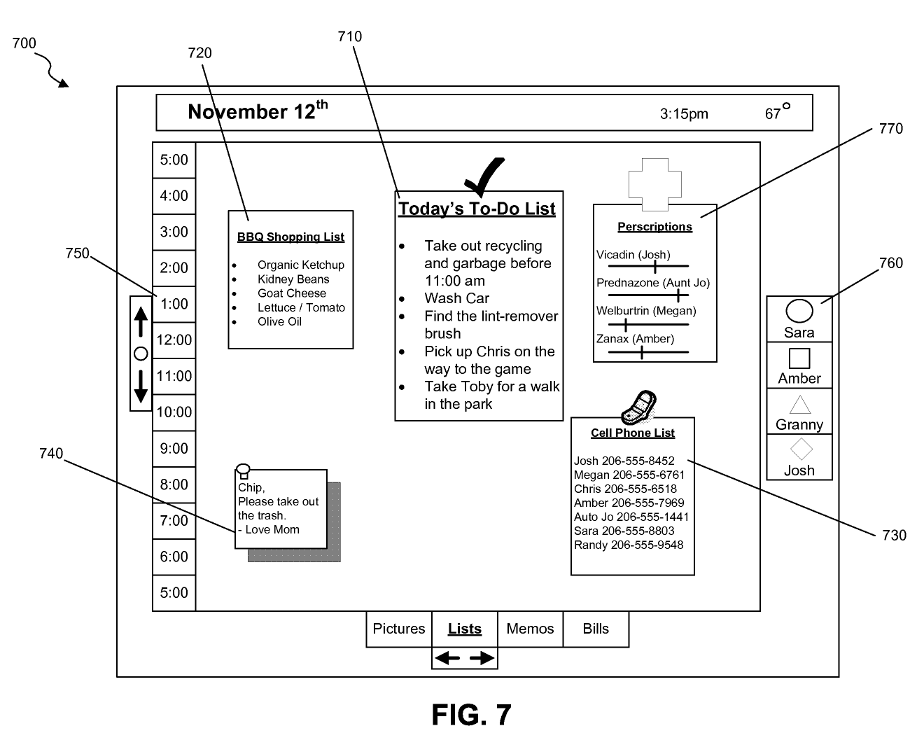

FIGS. 7-10 illustrate screenshots of user interface views from an illustrative family information management system, showing several of the aspects described above. Referring now to FIG. 7, user interface view 700 shows various user interface components displayed on the monitor 191, or other display, of a device running family information management system software. Users of this device are presented with different types of items from the data store 210 in different forms on the monitor 191. In this example, lists 710-730 present data to the user from the data store (e.g., internal data store 210 or cloud data store 620) organized by certain characteristics of the data. Thus, “Today's To-Do List” 710 may have been generated by retrieving all family items from the data store which are tasks or activities, and which have an effective date matching the current date. “BBQ Grocery List” 720 may be generated by querying the data store for list items associated with a certain event (i.e., the BBQ). “Cell Phone List” 730 may have been generated by querying the data store for all family contacts with mobile phone listings, or might be further pared down to display only the most frequently accessed numbers, or perhaps only cell phone numbers of family members. Like the lists 710-730, note 740 may be selected for display on the monitor 191 based on a query for note items in the data store. In order to display only the notes most likely to be relevant to the family members, the query may be restricted based on the creation time of the note 740, the sender and receiver of the note 740, and/or the known current or frequent users of the device. Thus, different sets of notes 740 may be automatically displayed at different times, or at the same time on different display devices connected to the system 200.

User interface view 700 also displays a time scale 750. This scale may be set by default to the current time, or a range around the current time, and may also be interactive to allow users to see the activities, notes (e.g., messages between family members or personal reminders created by a single family member), and tasks, etc. scheduled for later on that day or for a completely different time and day. Upon detecting that the user has changed the time scale 750, the system may invoke a data store query based on the time selected to return and display a different set of relevant items.

User interface view 700 also displays a family member listing 760, including designated screen regions (e.g., buttons with the family member's name and/or chosen or personal icon and/or image) for different family members. Users may interact with the listing 760 to restrict the items shown in view 700 so that only items associated with a certain family member or a combination of family members are shown. When the user selection in the family member listing 760 is changed, for example, from “Amber” to “Family”(not shown) the data store may be re-queried to retrieve the set of relevant items associated with any of the family members. Since many more items are likely to be returned from this query, the query logic might automatically be configured to pare down the results displayed based on time or priority of the items returned.

The “Prescriptions” list 770 relates to prescription medicine schedules for different family members. As an example, since many families might not have a need for such a list, this list and the related functionality may be implemented as a plug-in module and installed subsequently to the installation of the out-of-the-box system 200. Additionally, as mentioned above, the data storage for this module might be physically separated from the data store 210 and the storage of other data items in the system 200. For example, the “Prescriptions” list 770 data might be stored in a separate data store, but on the same computer as the internal data store 210. Alternatively, the “Prescriptions” list 770 data may reside in an accessible cloud storage data store 620, or in an external data store 280 on another family computing device or a third-party server. For example, the family's pharmacy might maintain the data store for the medical prescriptions module, allowing secure connections to system 200 for family members to view and update prescription information, place new orders, or file insurance claims.

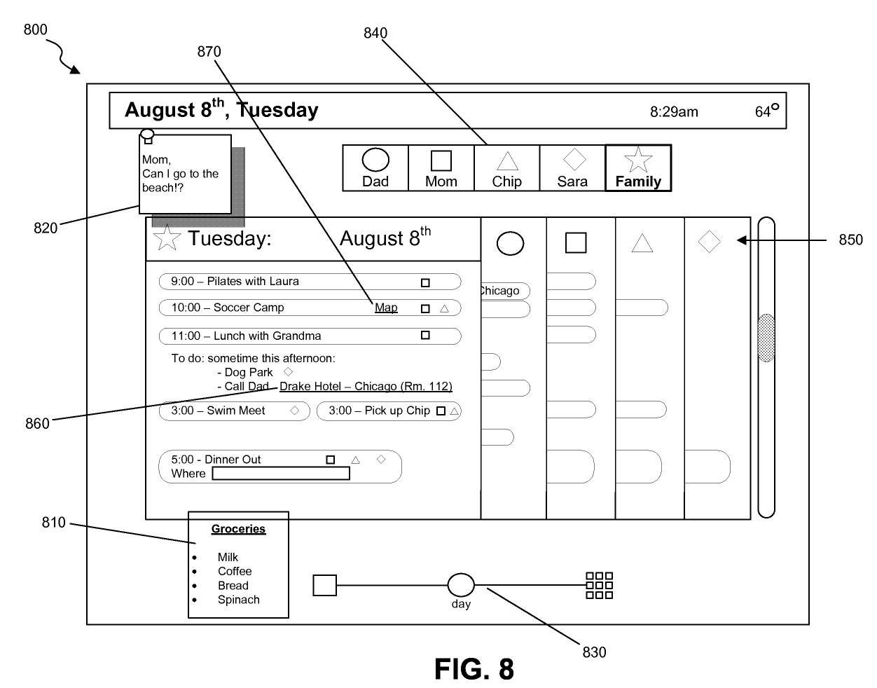

Referring now to FIG. 8, user interface view 800 displays different user interface components on the monitor 191. As mentioned above, the user interface views in the family information management system 200 may be customized based on the needs and preferences of the family members. Thus, as in view 700, view 800 contains a list 810, a note 820, a time scale 830, and a family member listing 840. Additionally, view 800 illustrates aspects by which family member's items may be separately displayed in the same overall view 800 with different user panes 850. Thus, a family member may interact with the user panes 850 to view their own schedules and information, or those of another family member or of the entire family. As mentioned above, certain family members may have permissions to block others from seeing certain appointments or information.

Additionally, view 800 contains user-selectable links 860 and 870. Links 860 and 870 notify the user that more information is available about the Drake Hotel (link 860) and that a map of the location of the Soccer Camp is available (link 870), while preserving screen real estate. Links 860 and 870 may be created and posted by family users, similar to the way that notes and appointments are created by family members. Links 860 and 870 may also be created automatically, for example, by searching related items in the family data store 210. As an example, regarding link 860, if Dad stayed at the Drake Hotel last month and entered address and phone number data for the hotel, the data may be archived and a search of the data store 210 might discover this data and associate it with a current event through link 860. Additionally, links 860 and 870 might be created through the use of an Internet text search or similar external query. For example, the link to the web site of the Drake Hotel in Chicago may be generated based on key words selected from the system 200 relating to Dad's business trip. Similarly, regarding link 870, if an address has been associated with the Soccer Camp activity, an Internet query of a location mapping web site may be used to generate link 870.

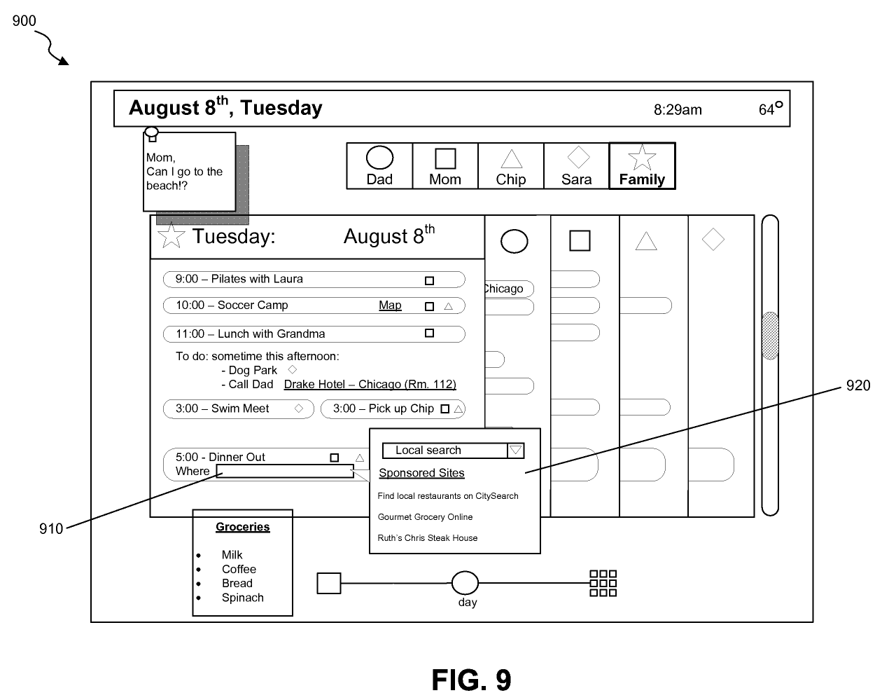

Referring now to FIG. 9, the user interface view 900 is shown in which the user interface of FIG. 8 has been altered in response to a user interaction with the family information management system 200. In this example, the event “Dinner Out” taking place at 5:00 in the afternoon on the currently displayed day has been selected. This selection may occur automatically based on the time of the upcoming event or a word search of the event description. Alternatively, the selection may be made by the user, for example, through a mouse-click or mouse-over event, or by tapping a touch screen of the device. In response to the selection of “Dinner Out”, or more specifically in response to the selection of the “Where” component 910 of the “Dinner Out” event, a text box 920 is displayed on the screen. Text box 920 presents the user with options relating to restaurant selection for this event. Restaurant suggestions may be generated automatically, for example, based on user favorites, family favorites, past restaurant selections, or a location search, based on items stored in the data store 210. Suggestions may also come from an advertising source, as described above, based on the location or key words of the event or related events.

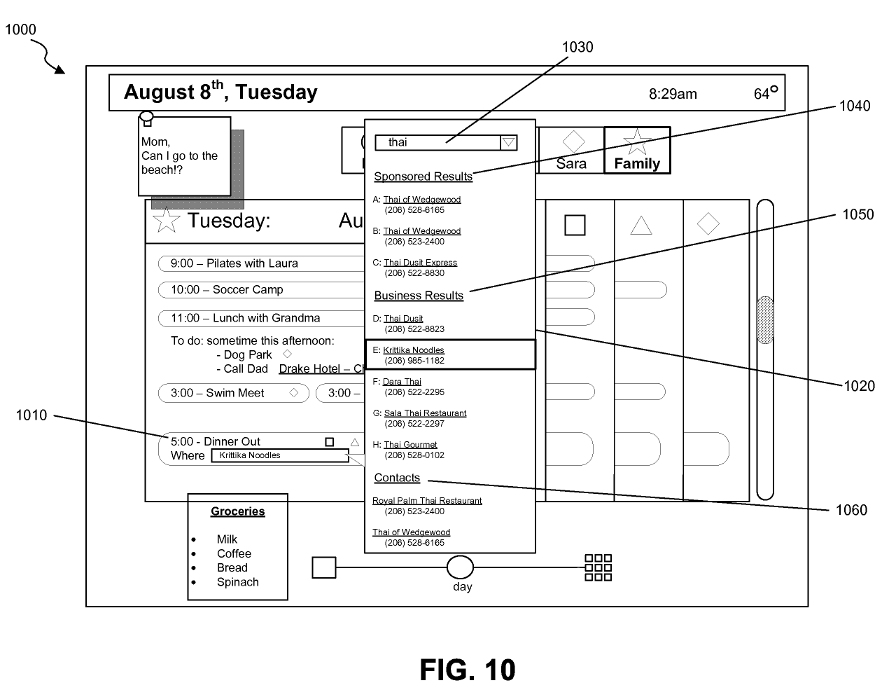

Referring now to FIG. 10, the user interface view 1000 is shown in which the user interface of FIG. 9 has been altered in response to another user interaction. In this example, the user might have selected “Find local restaurants on Citysearch” from text box 910 in view 900. In response, the text box 1020 may appear on the display, delivering to the use (e.g., displaying) text search functionality 1030, sponsored results 1040, text search results 1050, and matching contacts 1060. In this example, the user selection of a restaurant from text box 1020 may populate the name and/or location of the selected restaurant back into the “Where” component 1010 of the “Dinner Out” event, and may update the data store 210 accordingly with the new location information for the event.

While illustrative systems and methods as described herein embodying various aspects of the present invention are shown, it will be understood by those skilled in the art, that the invention is not so limited. Modifications may be made by those skilled in the art, particularly in light of the foregoing teachings. It will also be appreciated and understood that modifications may be made without departing from the true spirit and scope of the present invention. The description is thus to be regarded as illustrative instead of restrictive on the present invention.

What is claimed is:

1. A method for managing family information comprising:
defining in a data store a family comprising a plurality of individual family members;
storing in the data store a first item associated with a first member of the family;
storing in the data store a second item associated with a second member of the family;
storing in the data store a third item associated with the family as a whole;
receiving based on user input an item query comprising at least one of a family member identifier, a time identifier, and an item type identifier;
retrieving from the data store a set of items based on the item query, said set of items comprising the third item and at least one of the first item and the second item; and
returning the retrieved set of items, each item comprising an item type identifier and item data.

2. The method of claim 1, wherein each item in the data store is assigned a level of permission, the level of permission determining the accessibility of the item to each of the family members.

3. The method of claim 1, wherein the data store is located on a first computing device, the first computing device being installed at a home of at least one of the family members.

4. The method of claim 3, wherein receiving the item query includes receiving the item query from a second computing device, and the retrieving from the data store comprises:
synchronizing a second data store at the second computing device with the data store at the first computing device; and
executing the query against the second data store.

5. The method of claim 1, wherein the set of items retrieved comprises a note item, corresponding to a note sent between family members.

6. The method of claim 1, wherein the set of items retrieved comprises an appointment item, corresponding to a calendar appointment associated with at least one the family members.

7. The method of claim 1, wherein the set of items retrieved comprises a task item, corresponding to a task scheduled for at least one the family members.

8. The method of claim 1, wherein the set of items retrieved comprises a contact item, corresponding to a contact associated with at least one the family members.

9. The method of claim 1, wherein the item query is received and parsed at a first computing device, and the method further comprises:
based on the item query, determining that the data store is located at a second computing device at a remote location;
establishing a connection to the second computing device; and
requesting from the data store items based on the item query.

10. The method claim 1, further comprising:
transmitting information to an advertising entity based on the item query received from the user;
receiving advertising content from the advertising entity in response to the transmitted information; and
delivering the advertising content to the user.

11. One or more computer readable media storing computer-executable instructions which, when executed on a computer system, perform a method comprising:
storing in a computer storage one or more items associated with a first member of a family and not associated with a second member of the family, each item having an item type and item data;
storing in the computer storage one or more items associated with the family as a whole, each item having an item type and item data;
receiving based on user input an item query at the computer storage;
determining that the user has permission to execute the item query on the computer storage;
executing the item query on the computer storage; and
returning a set of items based on the query to the user, wherein the user has permission to access each of the returned items.

12. The computer readable media according to claim 11, wherein the computer storage contains at least one item not returned to the user based on a determination that the user does not have permission to receive the at least one item.

13. The computer readable media according to claim 11, wherein the item query comprises an update query, and determining that the user has permission to execute the item query comprises determining that the user has permission to write to the computer storage.

14. The computer readable media according to claim 11, wherein the returned set comprises a set of items including at least one of a task item, a calendar item, a contact item, and a note item.

15. The computer readable media according to claim 11, wherein the item query is received and parsed at a first computing device, and the method further comprises:
based on the item query, determining that the data store is located at a second computing device at a remote location;
establishing a connection to the second computing device; and
requesting from the data store items based on the item query.

16. The computer readable media according to claim 11, the method further comprising:
transmitting information to an advertising entity based on the item query received from the user;
receiving advertising content from the advertising entity in response to the transmitted information; and
delivering the advertising content to the user.

17. A system for displaying family information, comprising:
a plurality of computing devices, each comprising a display; and
a data store comprising a computer storage and a processor performing the steps of:
storing in the computer storage one or more items associated with a first member of a family, each item having an item type and item data;
storing in the computer storage one or more items associated with the family as a whole, each item having an item type and item data;
receiving an item query from one of the plurality of computing devices;
identifying a user associated with the computing device;
determining that the user has permission to execute the item query on the computer storage;
executing the item query on the computer storage; and
returning a result set from the executed query.

18. The system of claim 17, wherein query comprises an request query, and wherein the computer storage contains at least one item not returned in the result set based on a determination that the user does not have permission to receive the at least one item.

19. The system of claim 17, wherein the item query comprises an update query, and determining that the user has permission to execute the item query comprises determining that the user has permission to write to the computer storage.

20. The system of claim 17, wherein the result set comprises a set of items including at least one of a task item, a calendar item, a contact item, and a note item.
